(19) United States
(12) Patent Application Publication
(10) Pub. No.: US 2005/0005673 A1
(43) Pub. Date: Jan. 13, 2005

(54) Ferrite system

(75) Inventors: Franz Hillenmayer, Berglengenfeld (DE); Peter Turban, Maxhutte-Haidhof (DE)

Correspondence Address: BAKER BOTTS, LLP, 910 LOUISIANA, HOUSTON, TX, 77002-4995, US

(73) Assignee: Siemens Aktiengesellschaft

(21) Appl. No.: 10/887,639

(22) Filed: Jul. 9, 2004

(30) Foreign Application Priority Data
Jul. 10, 2003 (DE) DE10331316.8

(51) Int. Cl. G01L 27/00

(52) U.S. Cl. 73/1.57

(57) ABSTRACT

A ferrite system for a sensor for monitoring tire pressure and/or tire temperature, comprises a transformer (3) whose primary coil is in the form of a tire antenna (29) and a stray coil (5), the transformer (3) and the stray coil (5) both being in the form of toroids and the transformer (3) and the stray coil (5) being arranged coaxially on their central axis (M) on a support (7).

### PRIORITY

This application claims priority to German Application No. 103 31 316.8 filed Jul. 10, 2003.

### TECHNICAL FIELD OF THE INVENTION

The present invention relates to a ferrite system.

### BACKGROUND OF THE INVENTION

Such systems are used in vehicular technology to measure or monitor tire pressure and tire temperature with a battery-free system. A system of this kind conventionally consists of a transceiver on the vehicle and a tire unit directly on the tire.

In the tire unit there is disposed not only a pressure or temperature sensor and further electronics but also what is known as a ferrite system. This ferrite system establishes the electrical connection and the adjustment between a 360° tire antenna disposed in the sidewall of the tire and the vehicle electronics.

A ferrite system of this kind conventionally consists of a transformer. In patent application DE 102 55 376, which does not form part of the published prior art, a ferrite system of this kind additionally has a stray coil in order to achieve good shielding effectiveness against an external magnetic field.

The ferrite system, together with a capacitor, forms an oscillating circuit via which a charging capacitor is charged and communication is established. Owing to the fluctuations in the temperature of a vehicle tire the whole tire unit has to be capable of functioning over a wide temperature range.

In addition, the resonant frequency of the oscillating circuit has to remain in a specific range because of radio approval. To achieve the required electrical data for good coupling using the ferritic materials available, the transformer and any additional stray coil must have certain minimum dimensions. On the other hand, the tire electronics are required to be as small as possible so as to be able to exist mechanically in the tire.

### SUMMARY OF THE INVENTION

The object of the present invention is therefore to provide a ferrite system for a tire unit which has structural dimensions as small as possible yet meets the electrical and physical requirements.

This object can be achieved, according to the invention, by a ferrite system for a sensor for monitoring tire pressure and/or tire temperature, comprising a transformer whose primary coil is in the form of a tire antenna and a stray coil, wherein the transformer and the stray coil are both in the form of toroids and the transformer and the stray coil are arranged coaxially on their central axis on a support.

The object can also be achieved by a sensor for monitoring tire pressure and/or tire temperature, comprising a toroidal transformer whose primary coil is in the form of a tire antenna, and a toroidal stray coil, wherein the transformer and the stray coil are arranged coaxially on their central axis on a support.

The stray coil can be connected in series to a secondary coil of the transformer. The tire antenna can be passed both through the transformer and through the stray coil. The support may have an axial tunnel which is disposed on the central axis and through which the tire antenna is threaded. The support between the transformer and the stray coil can be reinforced with a plastic web.

The embodiment, according to the invention, both of the transformer or rather of its secondary coil and ferrite core and of the stray coil in the form of toroids now makes it possible to arrange these coaxially and therefore compactly and, at the same time, to meet the required specifications in terms of electrical and physical values.

In a preferred embodiment, both the stray coil and the transformer are arranged coaxially, spaced a small distance mutually apart, on a support, the support having a coaxial tunnel, with the result that the tire antenna passes through this tunnel.

In a further embodiment, the stray coil is connected in series to the transformer or rather a secondary coil thereof, with the result that advantageously only two connections or pins lead outwards.

In a further embodiment of the invention the support, which is made from plastic for example, can have a web between the two toroids, with the result that advantageously the tire unit housing is further reinforced.

In the preferred embodiment involving connection in series, in particular on a common coaxial support, a ferrite system of this kind is advantageously of a compact and modular structure, with the result that the ferrite system can also be made as a separate component and can be connected to a further electronic component by means of only two pins.

Furthermore, the coaxial arrangement, according to the invention, of the stray coil and of the transformer enables more reasonably priced electronics, in particular encapsulated electronics, to be used as a result of the small overall height thereby achieved. As a result of the small overall height of the ferrite system there is therefore sufficient space for better and structurally larger electronics.

### BRIEF DESCRIPTION OF THE DRAWINGS

The invention is explained in detail below with reference to an exemplary embodiment shown in the drawings.

The drawings show the following:

FIG. 1: a ferrite system according to the invention;

FIG. 2: the ferrite system shown in FIG. 1 in an exploded view;

FIG. 3: a ferrite system as shown in FIG. 1 with additional electronics in the form of a tire unit; and

FIG. 4: the tire unit shown in FIG. 3, arranged in a tire of a motor vehicle.

### DETAILED DESCRIPTION OF EMBODIMENTS

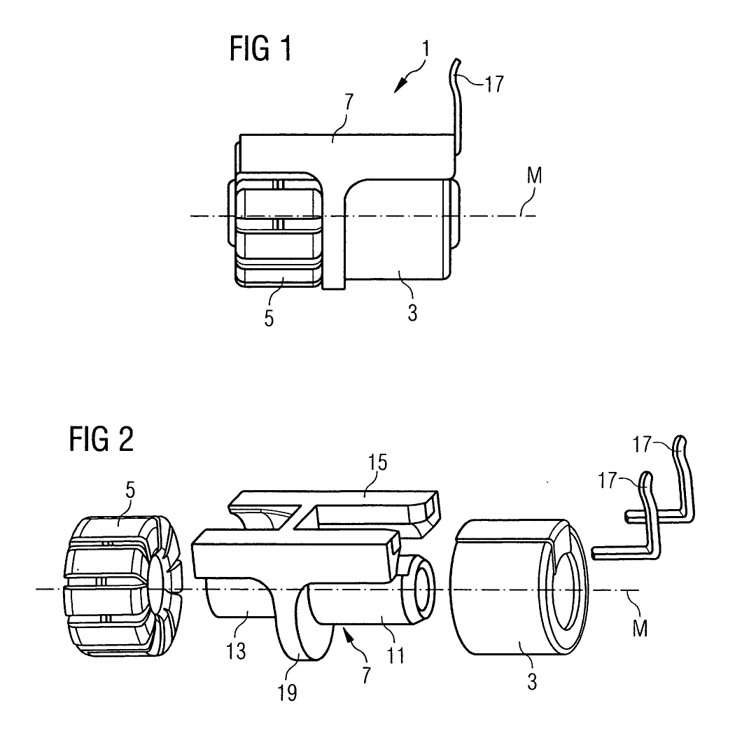

The ferrite system 1 shown in FIGS. 1 and 2 consists of a secondary coil of a transformer having a winding with few turns, hereinafter referred to as transformer 3, and of a stray coil 5, both of which are in the form of “toroids”.

The stray coil 5 and the transformer 3 are placed on opposite coaxial hollow cylindrical extensions 11 and 13 of a support 7, in particular of a plastic support.

The transformer 3 and stray coil 5 are therefore positioned on a central axis M, which runs perpendicularly to an end toroid plane or ring plane.

The configuration of the extensions 11 and 13 and the configuration as a common lead-through tunnel ensure that a tire antenna 29, which also forms the primary coil of the transformer 3, can be passed through this tunnel.

On its upper side the support 7 has a bearing face 15, which is parallel in a tangential plane to the two toroids and on which there can be arranged a further wheel electronics unit 9 having active and passive components, preferably in an encapsulated embodiment.

In the advantageous embodiment, this wheel electronics unit 9 can be electrically connected by means of only two connections 17 to a series connection (not shown in detail in the figures) of the transformer 3 or rather of the secondary coil and of the stray coil 5.

The support 7 can also have a reinforcement 19 (for example in the form of an annular web), which is arranged between the two toroids. This makes the whole of the ferrite system (housing), including the wheel electronics unit 9 arranged thereon, more mechanically stable.

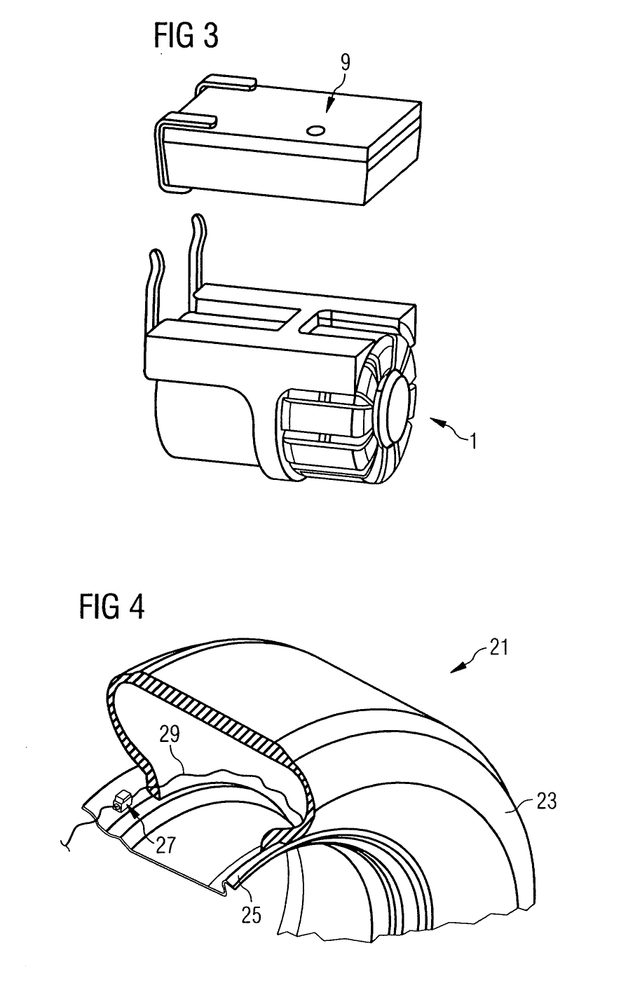

FIGS. 3 and 4 show how a tire unit 27, consisting of the inventive ferrite system 1 and a wheel electronics unit 9, can be used on a wheel 21 of a motor vehicle. Here both the tire unit 27 and the tire antenna 29 extending around the tire are positioned in or on a tire 23, which is arranged on a wheel rim 25.

This arrangement highlights how the configuration, according to the invention, of a coaxial arrangement of transformer 3 and stray coil 5, with the tire antenna 29 additionally passed through, makes it possible to achieve an arrangement which makes optimal use of the space available.

1. A ferrite system for a sensor for monitoring tire pressure and/or tire temperature, comprising a transformer whose primary coil is in the form of a tire antenna and a stray coil, wherein the transformer and the stray coil are both in the form of toroids and the transformer and the stray coil are arranged coaxially on their central axis on a support.

2. The ferrite system according to claim 1, wherein the stray coil is connected in series to a secondary coil of the transformer.

3. The ferrite system according to claim 1, wherein the tire antenna is passed both through the transformer and through the stray coil.

4. The ferrite system according to claim 2, wherein the tire antenna is passed both through the transformer and through the stray coil.

5. The ferrite system according to claim 3, wherein the support has an axial tunnel which is disposed on the central axis and through which the tire antenna is threaded.

6. The ferrite system according to claim 4, wherein the support has an axial tunnel which is disposed on the central axis and through which the tire antenna is threaded.

7. The ferrite system according to claim 1, wherein the support between the transformer and the stray coil is reinforced with a plastic web.

8. A sensor for monitoring tire pressure and/or tire temperature, comprising:
a toroidal transformer whose primary coil is in the form of a tire antenna,
a toroidal stray coil, wherein the transformer and the stray coil are arranged coaxially on their central axis on a support.

9. The sensor according to claim 8, wherein the stray coil is connected in series to a secondary coil of the transformer.

10. The sensor according to claim 8, wherein the tire antenna is passed both through the transformer and through the stray coil.

11. The sensor according to claim 9, wherein the tire antenna is passed both through the transformer and through the stray coil.

12. The sensor according to claim 10, wherein the support has an axial tunnel which is disposed on the central axis and through which the tire antenna is threaded.

13. The sensor according to claim 11, wherein the support has an axial tunnel which is disposed on the central axis and through which the tire antenna is threaded.

14. The sensor according to claim 8, wherein the support between the transformer and the stray coil is reinforced with a plastic web.
